(19) United States
(12) Patent Application Publication
(10) Pub. No.: US 2025/0071779 A1
(43) Pub. Date: Feb. 27, 2025

(54) TECHNOLOGIES FOR MANAGING DISCONTINUOUS RECEPTION TIMERS

(71) Applicant: Apple Inc., Cupertino, CA (US)

(72) Inventors: Ralf Rossbach, Munich (DE); Fangli Xu, Beijing (CN); Weidong Yang, San Diego, CA (US); Naveen Kumar R. Palle Venkata, San Diego, CA (US); Zhibin Wu, Los Altos, CA (US); Alexander Sirotkin, Tel Aviv (IL); Haijing Hu, Los Gatos, CA (US); Yuqin Chen, Beijing (CN); Pavan Nuggehalli, San Carlos, CA (US)

(73) Assignee: Apple Inc., Cupertino, CA (US)

(21) Appl. No.: 18/727,335

(22) PCT Filed: Jan. 12, 2022
(86) PCT No.: PCT/CN2022/071609

§ 371 Date: Jul. 8, 2024

(51) Int. Cl. H04W 72/231; H04L 1/1812; H04L 5/00; H04W 72/0446; H04W 76/28

(52) U.S. Cl. CPC H04W 72/231; H04L 1/1812; H04L 5/0053; H04W 72/0446; H04W 76/28

(57) ABSTRACT

The present application relates to devices and components including apparatuses, systems, and methods for technologies for managing discontinuous reception timers in wireless networks.

### BACKGROUND

Third Generation Partnership Project (3GPP) Technical Specifications (TSs) define standards for New Radio (NR) wireless networks. One area of study for developing these TSs is managing discontinuous reception (DRX) timers.

### BRIEF DESCRIPTION OF THE DRAWINGS

FIG. 1 illustrates a network environment in accordance with some embodiments.

FIG. 2 illustrates a deferral operation in accordance with some embodiments.

FIG. 3 illustrates a cell switching operation in accordance with some embodiments.

FIG. 4 is a signaling diagram in accordance with some embodiments.

FIG. 5 illustrates a codebook retransmission in accordance with some embodiments.

FIG. 6 illustrates a codebook in accordance with some embodiments.

FIG. 7 illustrates another codebook in accordance with some embodiments.

FIG. 8 is another signaling diagram in accordance with some embodiments.

FIG. 9 illustrates an operational flow/algorithmic structure in accordance with some embodiments.

FIG. 10 illustrates another operational flow/algorithmic structure in accordance with some embodiments.

FIG. 11 illustrates another operational flow/algorithmic structure in accordance with some embodiments.

FIG. 12 illustrates another operational flow/algorithmic structure in accordance with some embodiments.

FIG. 13 illustrates another operational flow/algorithmic structure in accordance with some embodiments.

FIG. 14 illustrates a user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

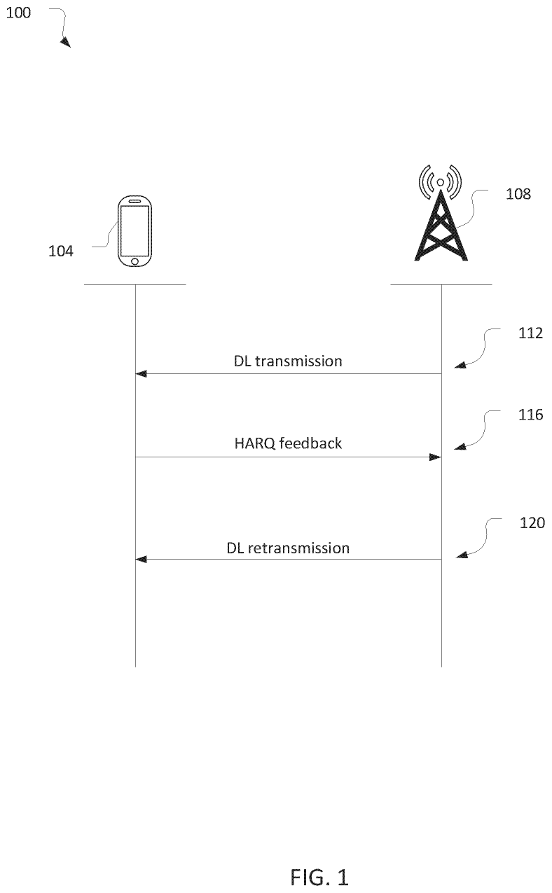

FIG. 1 illustrates a network environment 100 in accordance with some embodiments. The network environment 100 may include a user equipment (UE) 104 communicatively coupled with a base station 108. The UE 104 and the base station 108 may communicate over air interfaces compatible with 3GPP TSs such as those that define Fifth Generation (5G) NR system standards. The base station 108 may be a gNB to provide one or more 5G New Radio (NR) cells that present NR user plane and control plane protocol terminations toward the UE 104.

The UE 104 may be configured for discontinuous reception (DRX) operation, which allows the UE 104 to transition to low-power operation during times in which signals are not expected to be received from the base station 108. Some of these times may occur with respect to hybrid automatic repeat request (HARQ) operation.

FIG. 1 includes a simple signaling flow to illustrate DRX/HARQ operation in accordance with some embodiments. At 112, the base station 108 may transmit a downlink transmission to the UE 104. The UE 104 may generate HARQ feedback based on an attempt to receive the downlink transmission. If the downlink transmission is properly received and decoded, the HARQ feedback may include a HARQ acknowledgment (ACK). If the downlink transmission is not properly received or decoded, the HARQ feedback may include a HARQ negative acknowledgment (NACK). At 116, the UE 104 may transmit the HARQ feedback to the base station 108. If the base station 108 receives a HARQ NACK, the base station 108 may send a downlink retransmission at 120.

The HARQ feedback may include one logical bit per transport block. The UE 104 may support a plurality of HARQ processes (for example, up to sixteen per component carrier), with separate feedback provided for each HARQ process. A HARQ-ACK codebook may be a sequence of bits constructed using ACK/NACK feedback corresponding to a plurality of PDSCH reception attempts in a configured time window.

3GPP Release 16 provides three types of HARQ-ACK codebooks. A Type-1 codebook may be a fixed-size codebook semi-statically configured by the base station 108 via radio resource control (RRC) signaling. A Type-2 codebook may have a dynamic size that changes according to resource allocation. A Type-3 codebook may include feedback for all HARQ processes and all configured cells. The base station 108 may request a Type-3 codebook using a one-shot trigger. Release 17 has introduced Enhanced Type-3 codebook (e-Type3) that leverages the design of the Type-3 codebook but reduces feedback overhead. The e-Type3 codebook is described in further detail elsewhere herein.

Type-1 and Type-2 codebooks may be supported for both licensed spectrum and unlicensed spectrum. Type-3 codebooks may be applicable for NR-unlicensed (NR-U).

Given the HARQ operation shown in FIG. 1, there may be periods of time in which the UE 104 does not expect to receive a transmission and other periods of time in which the UE 104 expects to receive a transmission. The UE 104 may utilize DRX HARQ timers to track these periods of time and operate accordingly.

Two DRX HARQ timers include a DRX HARQ round trip time (RTT) timer for the downlink (drx-HAR-RTT-TimerD) L.) and a DRX retransmission timer for the downlink (drx-Retransmission TimerD) L). A drx-HAR-RTT-TimerIL timer may also be referred to herein simply as an “RTT timer,” and a drx-RetransmissionTimerDL may also be referred to herein simply as a “retransmission timer.”

The RTT timer may provide a minimum duration before a downlink assignment for a HARQ retransmission is expected by a media access control (MAC) entity of the UE 104. One RTT timer may be configured per downlink HARQ process except for a broadcast process. The retransmission timer may provide a maximum duration until a downlink retransmission is received. The retransmission timer may be typically started when the RTT timer expires. One retransmission timer may be configured for each downlink HARQ process except for the broadcast process.

For example, with reference to FIG. 1, the UE 104 may start an RTT timer after transmitting the HARQ feedback 116. The UE 104 may enter a sleep mode when the RTT timer is running for the HARQ process and no retransmission timer is running for other HARQ processes. When the RTT timer expires, the UE 104 may power-up the receive chain circuitry and start the retransmission timer for the HARQ process. While the retransmission timer runs, the UE 104 may monitor a physical downlink control channel (PDCCH) in an attempt to decode scheduling information for the downlink retransmission at 120.

In some embodiments, the base station 108 may manage RTT and retransmission timers in a manner similar to the UE 104. The timers at the base station 108 may be in sync with the timers at the UE 104. In this manner, the base station 108 is able to track or identify periods of time in which the UE 104 is able to receive the PDCCH, etc.

DRX operation with respect to the timers is described in clause 5.7 of 3GPP TS 38.321 v16.7.0 (2021-12) as follows:

When DRX is configured, the MAC entity shall:

| 1> | if a MAC PDU is received in a configured downlink assignment: | |
|---|---|---|
| | 2> | start the drx-HARQ-RTT-TimerDL for the corresponding HARQ |
| | | process in the first symbol after the end of the corresponding |
| | | transmission carrying the DL HARQ feedback; |
| | 2> | stop the drx-RetransmissionTimerDL for the corresponding |
| | | HARQ process. |

3GPP Release 17 provides a number of layer 1 (L1) features designed to enhance HARQ feedback. These features include semi-persistent scheduling (SPS) PDSCH HARQ deferral; PUCCH cell switching; HARQ-ACK codebook retransmission; and one shot HARQ-ACK request and Enhanced Type-3 HARQ-ACK codebook reports. These features may be used independently or with one or more other features. Some embodiments describe simultaneous configurations with respect to some of these features, but other independent/simultaneous configurations may also be used.

Embodiments describe extensions/updates to DRX HARQ timers that may be used with one or more of these L1 features to help reduce power consumption, increase efficient utilization of system resources, and reduce latency. While many of the embodiments are described with respect to Release 17 features, some embodiments may also be applicable to Release 16 features.

SPS HARQ-ACK deferral may address situations in which a PUCCH carrying SPS HARQ feedback is dropped due to a conflict with a downlink symbol on a TDD carrier. This may happen if the SPS periodicity does not match the periodicity of the downlink/uplink partition, which may inevitably result in some occasions for PUCCH carrying SPS HARQ feedback at least partially overlapping with downlink symbols.

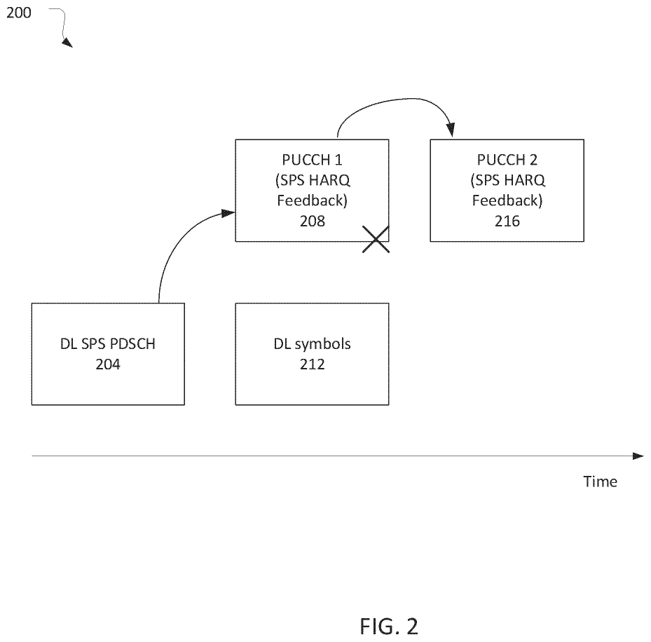

FIG. 2 illustrates an SPS HARQ-ACK deferral operation 200 in accordance with some embodiments. The operation 200 may include the UE 104 attempting to receive a DL SPS PDSCH 204. The UE 104 may then identify a first PUCCH resource (PUCCH 1) 208 of an initial slot/sub-slot that is to carry SPS HARQ feedback that indicates whether the DL SPS PDSCH was properly received. The PUCCH 1 208 may be indicated by an SPS-PUCCH-AN-list or an n1PUCCH-AN. However, in this instance, the PUCCH 1 208 may not be valid due to a conflict with DL symbols 212. Thus, the UE 104 may defer transmission of the SPS HARQ feedback to a second PUCCH resource (PUCCH 2) 216. In some embodiments, the deferred SPS HARQ-ACK bits may be appended to non-deferred HARQ bits in PUCCH 2 216.

SPS HARQ ACK deferral may help to avoid dropping SPS HARQ-ACK on a TDD carrier. This may improve system capacity and power consumption by the UE 104.

The SPS HARQ ACK deferral may be triggered after UCI multiplexing in some instances and may be largely transparent to a MAC entity. SPS HARQ ACK deferral may apply to HARQ-ACK codebooks of Type 1 or Type 2.

As shown above, when the SPS HARQ ACK is deferred the corresponding HARQ-ACK may happen in a PUCCH on a later slot/sub-slot. This may be clarified by providing a note to provide additional context to clarify the behavior of the MAC entity with respect to the DRX HARQ timers. In some embodiments, the note may be provided by adding the underlined text to clause 5.7 of 3GPP TS 38.321 v16.7.0 (2021-12) as follows:

When DRX is configured, the MAC entity shall:

| 1> | if a MAC PDU is received in a configured downlink assignment: | |
|---|---|---|
| | 2> | start the drx-HARQ-RTT-TimerDL for the corresponding |
| | | HARQ process in the first symbol after the end of the |
| | | corresponding transmission carrying the DL HARQ feedback; |
| | 2> | stop the drx-Retransmission TimerDL for the corresponding |
| | | HARQ process. |

NOTE X: When the HARQ feedback is subject to SPS HARQ-ACK deferral as specified in TS 38.213 v17.0.0 (2021-12), the corresponding transmission carrying the DL HARQ feedback occurs in a PUCCH resource with a PUCCH transmission in a later slot.

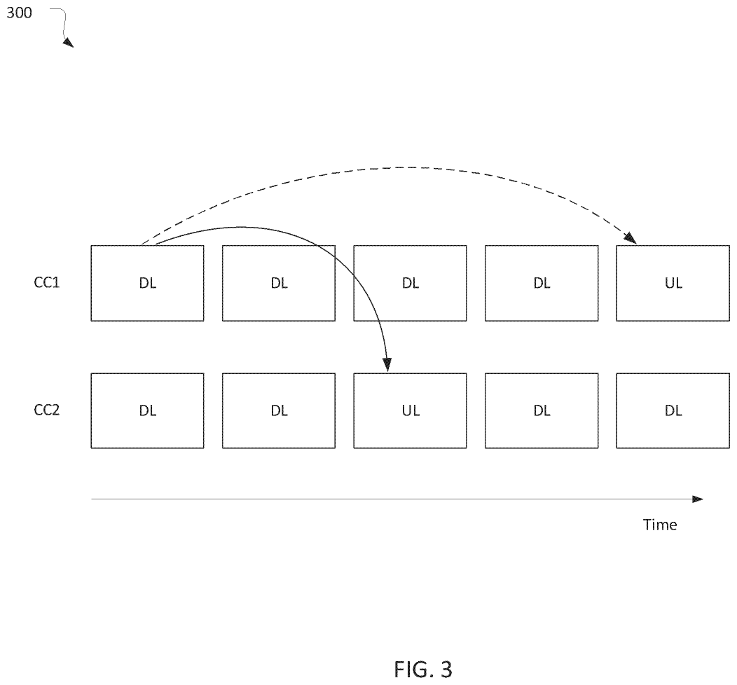

FIG. 3 illustrates a PUCCH cell switching operation 300 in accordance with some embodiments. PUCCH cell switching may be used to reduce HARQ feedback latency with respect to inter-band time division duplex (TDD). In this embodiment, two component carriers (CC1 and CC2) may be configured with different uplink/downlink TDD configurations. CC1 may be a primary serving cell (PCell) in band Y and CC2 may be a secondary serving cell (SCell) in band Z.

Limiting HARQ feedback to the same carrier as the downlink transmission to which it corresponds may result in unnecessarily long uplink control information (UCI) or HARQ feedback latency. For example, in CC1, HARQ feedback corresponding to a downlink transmission in a first slot may not be transmitted until the PUCCH of the uplink slot that is four slots later. PUCCH cell switching may allow HARQ feedback, corresponding to a downlink transmission in CC1, to be transmitted sooner in a PUCCH in CC2. As shown, the PUCCH may be transmitted two slots after the downlink transmission.

PUCCH cell switching, which may also be referred to as PUCCH carrier switching, may be configured in a semi-static manner or a dynamic manner. Typically, only one of the semi-static (periodic) PUCCH carrier switching or dynamic PUCCH carrier switching is configured on a given time. PUCCH carrier switching may be enabled between two TDD cells with the PUCCH configured on a normal uplink (NUL) carrier.

Semi-static (periodic) PUCCH carrier switching operation may be based on RRC configured PUCCH cell timing pattern of applicable PUCCH cells. Semi-static PUCCH carrier switching may support switching across cells with different numerologies. Semi-static PUCCH cell switching may be applicable to all UCI types including HARQ-ACK, scheduling request (SR), and channel state information (CSI). Semi-static PUCCH cell switching may be simultaneously configured with SPS HARQ-ACK deferral (for example, for downlink SPS). Semi-static PUCCH cell switching may also apply in combination with HARQ-ACK codebook types 1, 2, or 3 including, for example, HARQ-ACK retransmission and usage of Type-3 HARQ-ACK codebook.

Dynamic PUCCH carrier switching may be based on a dynamic indication in a DCI format scheduling a PUCCH. This type of PUCCH carrier switching may be applicable to HARQ-ACK only. Dynamic PUCCH cell switching can be combined with HARQ-ACK codebook type 1, 2, or 3.

DCI format 1_1/1_2 may include a PUCCH cell indicator that provides a dynamic PUCCH target carrier indication. The indication may apply to: HARQ-ACK for a PDSCH dynamically scheduled by DCI; HARQ-ACK corresponding to a first SPS PDSCH activated by activation DCI based on the indication in the activation DCI; HARQ-ACK corresponding to the SPS release DCI based on the indication in the release DCI; HARQ-ACK corresponding to SCell dormancy indication without scheduling a PDSCH; Release 16 Type-3 HARQ-ACK codebook (for example, one-shot HARQ-ACK request); Release 17 Enhanced Type-3 HARQ-ACK codebook; or Release 17 HARQ-ACK codebook retransmission based on the indication in the triggering DCI.

If PUCCH cell switching is applied, the corresponding HARQ-ACK will happen on a different PUCCH carrier. Apart from the RRC configuration, the PUCCH cell switching may be transparent to the MAC entity.

Operation of DRX timers may be clarified to accommodate PUCCH cell switching in accordance with some embodiments. The clarification may be structured into different notes. A first note, Note Y, may be for configured downlink assignment/SPS HARQ-ACK deferral simultaneously configured with semi-static PUCCH cell switching. A second note, Note X, may be for cases where the PDCCH is monitored. In some embodiments, these notes may be provided by adding the underlined text to clause 5.7 of 3GPP TS 38.321 as follows:

When DRX is configured, the MAC entity shall:

| 1> | if a MAC PDU is received in a configured downlink assignment: | |
|---|---|---|
| | 2> | start the drx-HARQ-RTT-TimerDL for the corresponding |
| | | HARQ process in the first symbol after the end of the |
| | | corresponding transmission carrying the DL HARQ feedback; |
| | 2> | stop the drx-Retransmission TimerDL for the corresponding |
| | | HARQ process. |

Note Y: When the UE is configured with a periodic cell switching pattern for PUCCH transmissions as specified in 3GPP TS 38.213, the corresponding transmission carrying the DL HARQ feedback can happen on a different PUCCH cell.
Note Z: When PUCCH cell switching is configured as specified in TS 38.213, the corresponding transmission carrying the DL HARQ feedback can happen on a different PUCCH cell.

In some instances, a HARQ-ACK codebook transmitted by the UE 104 in a first PUCCH resource of a first slot may not be received by the base station 108. Release 17 provides a mechanism in which the base station 108 can explicitly request a HARQ-ACK codebook retransmission in a one-shot manner. The base station 108 may trigger a retransmission of the HARQ-ACK codebook by using a DCI format that does not schedule a PDSCH reception. This type of HARQ-ACK retransmission may be applicable to HARQ-ACK codebook type 1 or 2. Thus, in some embodiments, the HARQ-ACK codebook retransmission request may be specific to one HARQ process only.

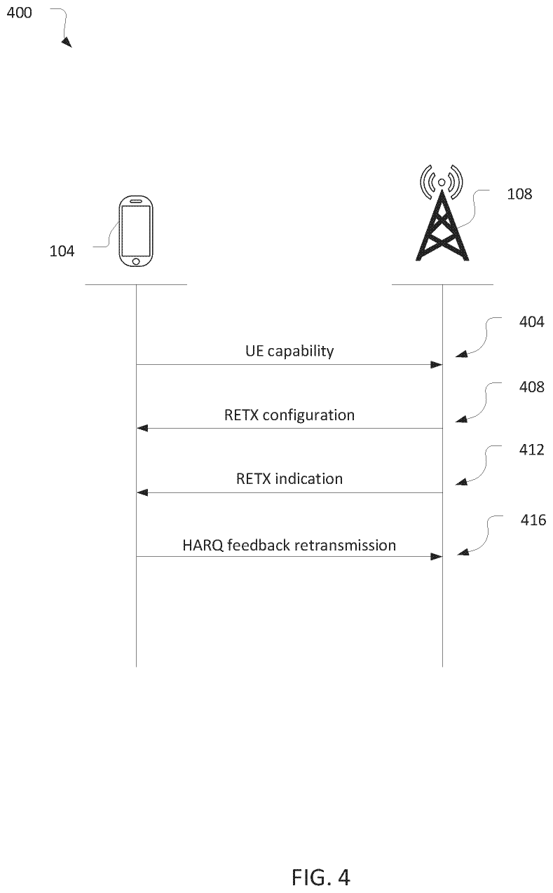

FIG. 4 is a signaling diagram 400 to illustrate a HARQ-ACK codebook retransmission in accordance with some embodiments. The signaling diagram 400 may include, at 404, the UE 104 transmitting a capability report that indicates the UE capability to support one-shot HARQ-ACK retransmission. In some embodiments, the capability report may report a UE capability for FG 25-7 (triggered HARQ-ACK codebook retransmission).

The signaling diagram 400 may further include, at 408, the base station 108 providing the UE 104 with a RETX configuration through RRC signaling. The RETX configuration may include a pdsch-HARQ-ACK-retx information element (IE) that configures the UE 104 with HARQ-ACK codebook retransmission.

The signaling diagram 400 may further include, at 412, the base station 108 transmitting an RETX indication to the UE 104. The RETX indication may indicate a request for HARQ-ACK codebook retransmission. The indication may be provided in a new DCI field through DCI format 1_1 or 1_2.

Upon receiving the RETX indication, the UE 104 may retransmit the HARQ-feedback. The HARQ feedback may include the HARQ-ACK codebook that was previously transmitted by the UE 104 but not successfully received by the base station 108.

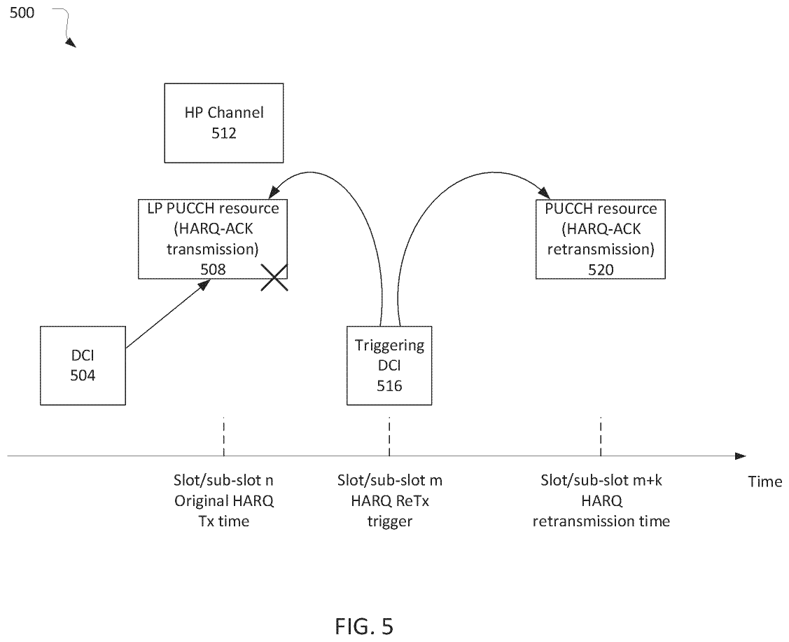

FIG. 5 illustrates a HARQ-ACK codebook retransmission 500 in accordance with some embodiments.

The UE 104 may receive a DCI 504 that schedules HARQ-ACK transmission to be in a relatively low-priority (LP) PUCCH resource 508. The LP PUCCH resource 508 may conflict with a relatively high-priority (HP) channel 512, which may result in the HARQ-ACK transmission being dropped. The base station 108 may then send a triggering DCI 516 for a one-shot HARQ-ACK retransmission in PUCCH resource 520.

The triggering DCI 516 may dynamically indicate a ‘HARQ re-tx offset’ that is used to define an offset in a number of PUCCH slots/sub-slots between a slot/sub-slot of the triggering DCI 516 and a slot/sub-slot of the PUCCH resource that has the HARQ-ACK codebook to be retransmitted. If the triggering DCI 516 is received in slot/sub-slot m, indicating the HARQ-ACK retransmission is to be transmitted in PUCCH resource 520 in slot/sub-slot m+k and indicating HARQ_retx_offset, the slot/sub-slot of the PUCCH resource having the HARQ-ACK codebook that is to be retransmitted is determined as n=m HARQ_retx_offset. The value range of HARQ_retx_offset may be fixed in a 3GPP TS.

HARQ-ACK codebook retransmission may impact the DRX timer handling by the MAC entity. For example, following reception of the HARQ-ACK retransmission indicator on the DCI, the UE 104 may need to start or restart the RTT timer in the first symbol after the end of the corresponding transmission carrying the retransmitted downlink HARQ feedback.

Updates to the language of clause 5.7 of 3GPP TS 38.321 may be needed to address a case in which the PDCCH indicates a request for HARQ-ACK retransmission without scheduling a downlink transmission. These updates may be provided according to either of the following two options.

In a first option, the following paragraph may be added to TS 38.321, clause 5.7 to treat the case in which the PDCCH indicates a HARQ-ACK retransmission without scheduling a DL transmission:

```
2> if the PDCCH indicates a HARQ-ACK retransmission
  without scheduling a DL transmission:
  3> start the drx-HARQ-RTT-TimerDL for the corresponding
      HARQ process in the first symbol after the end of the
      corresponding transmission carrying the DL HARQ
      feedback;
  3> stop the drx-RetransmissionTimerDL for the
      corresponding HARQ process.
```

In a second option, the language of 3GPP TS 38.321, clause 5.7 may be updated with the underlined text to include the case where the PDCCH indicates a HARQ-ACK retransmission without scheduling a DL transmission as follows:

| 1> | if a DRX group is in Active Time: | |
|---|---|---|
| | 2> | monitor the PDCCH on the Serving Cells in this DRX group as specified |
| | | in TS 38.213 [6]; |
| | 2> | if the PDCCH indicates a DL transmission or indicates a HARQ-ACK |
| | | retransmission without scheduling a DL transmission: |

| | |
|---|---|
| 3> | start the drx-HARQ-RTT-TimerDL for the corresponding HARQ |
| | process in the first symbol after the end of the corresponding |
| | transmission carrying the DL HARQ feedback; |

NOTE 3: When HARQ feedback is postponed by PDSCH-to-HARQ_feedback timing indicating a non-numerical kl value, as specified in TS 38.213 [6], the corresponding transmission opportunity to send the DL HARQ feedback is indicated in a later PDCCH requesting the HARQ-ACK feedback.

| 3> | stop the drx-RetransmissionTimerDL for the corresponding HARQ | |
|---|---|---|
| | process. | |
| 3> | if the PDSCH-to-HARQ_feedback timing indicate a non-numerical | |
| | k1 value as specified in TS 38.213 [6]: | |
| | 4> | start the drx-RetransmissionTimerDL in the first symbol |
| | | after the (end of the last) PDSCH transmission (within a |
| | | bundle) for the corresponding HARQ process. |

As briefly introduced above, Release 16 NR-U introduced the Type-3 codebook to enable the base station 108 to request the UE 104 to send HARQ-ACK feedback for all HARQ processes of all the configured cells by a one-shot trigger. Release 17 has introduced Enhanced Type-3 HARQ-ACK codebooks to reduce feedback overhead.

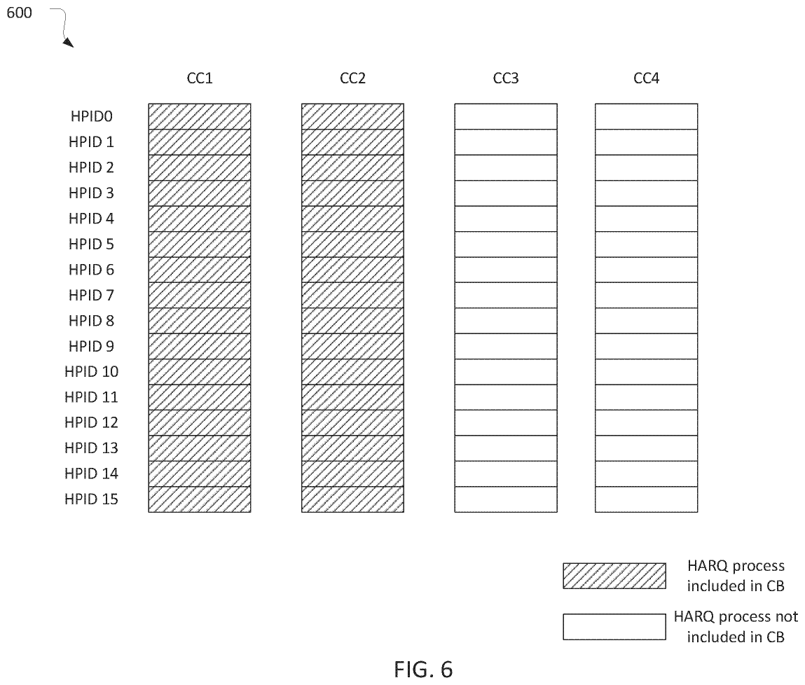

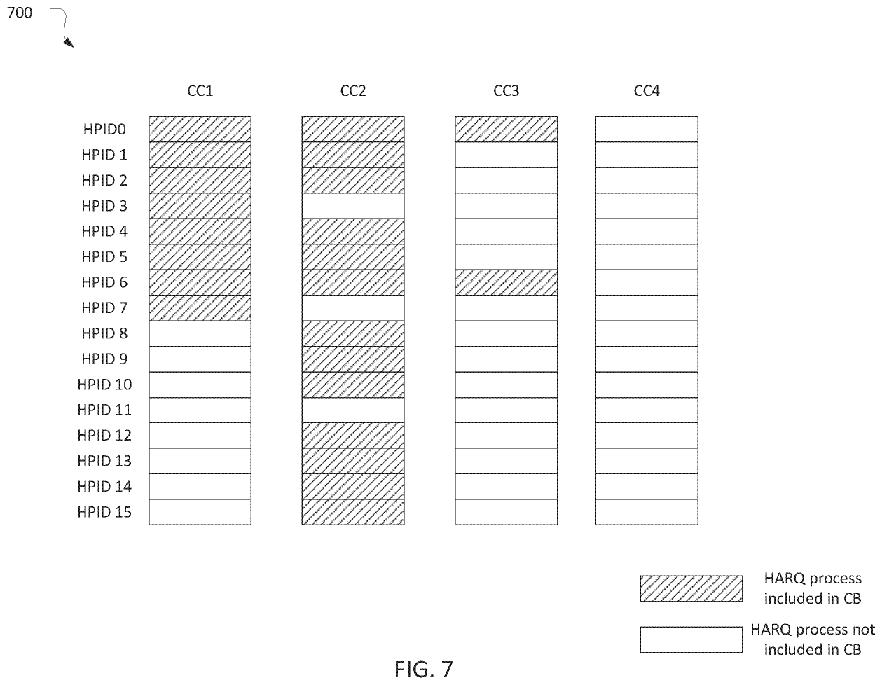

FIGS. 6 and 7 respectively illustrate Enhanced Type-3 HARQ-ACK codebooks 600 and 700 in accordance with some embodiments. The UE 104 may be configured with these codebooks through RRC signaling.

In contrast to the Type-3 HARQ-ACK codebook of Release 16, codebooks 600 and 700 each include HARQ feedback for a subset of HARQ processes. Each CC is shown with 16 HARQ process IDs (HPIDs), which respectively correspond to 16 HARQ processes.

The codebook 600 includes feedback for all HARQ processes that correspond to a subset of component carriers. In particular, the codebook 600 includes feedback for all HARQ processes of CC1 and CC2.

Codebook 600 may be configured by a pdsch-HARQ-ACK-enhType3perCC IE that configures one enhanced type 3 HARQ-ACK codebook using a per CC configuration. The IE may include an entry corresponding to each CC configuration. Thus, the number of entries may be one to a maximum number of serving cells. Each entry may be a one-bit value that indicates whether all the HARQ processes of the corresponding CC are included in the codebook (for example, the bit is set to ‘1’) or whether none of the HARQ processes of the corresponding CC are included in the codebook (for example, the bit is set to ‘0’).

The codebook 700 includes a subset of configured HARQ processes per CC. With codebook 700, different subsets of HARQ processes can be configured for each CC. As shown, the codebook 700 includes feedback for HPID0-HPID7 of CC1, all HPIDs of CC2 except HPID3, HPID7, and HPID 11; and HPID0 and HPID 6 of CC3.

Codebook 700 may be configured by a pdsch-HARQ-ACK-enhType3perHARQ IE that configures one enhanced type 3 HARQ-ACK codebook using a per HARQ process and CC configuration. The IE may include an entry corresponding to each CC configuration. Thus, the number of entries may be one to a maximum number of serving cells. Each entry may be a sixteen-bit value, with each bit corresponding to a respective HARQ process of the corresponding CC. A bit may indicate whether the corresponding HARQ process of the CC is included in the codebook (for example, the bit is set to ‘1’) or not included in the codebook (for example, the bit is set to ‘0’).

Subject to capability of the UE 104, the base station 108 may configure up to eight Enhanced Type-3 HARQ-ACK codebooks. These codebooks may be dynamically requested on the DCI together with or as one-shot HARQ-ACK.

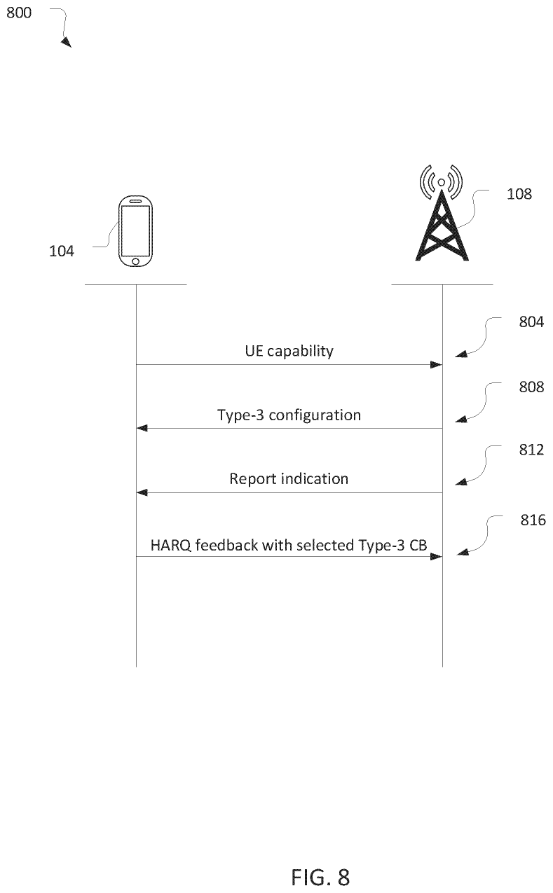

FIG. 8 is a signaling diagram 800 to illustrate a Type-3 codebook reporting process in accordance with some embodiments.

The signaling diagram 800 may include, at 804, the UE 104 transmitting a capability report that indicates the UE capability to support enhanced Type-3 HARQ-ACK codebook reporting. If the UE 104 supports said reporting, the capability report may also indicate a number of Enhanced Type-3 codebooks that are supported.

The signaling diagram 800 may further include, at 808, the base station 108 providing the UE 104 with a Type-3 configuration through RRC signaling. The Type-3 configuration may include one or more IEs to configure the UE 104 for Type-3 reporting. The IEs may include, but are not limited to, a pdsch-HARQ-ACK-enhType3 IE, a pdsch-HARQ-ACK-enhType3List IE, a pdsch-HARQ-ACK-enhType3DCI field IE.

The signaling diagram 800 may further include, at 812, the base station 108 transmitting a report indication to the UE 104. The report indication may include a one-shot HARQ-ACK request (for a Release 16 Type-3 codebook report, for example) or an Enhanced Type-3 Codebook indicator (for a Release 17 Enhanced Type-3 codebook report, for example). The report indication may be provided through DCI format 1_1 or 1_2, which may also schedule PDSCH in some situations.

Upon receiving the report indication, the UE 104 may send the HARQ-feedback with the selected Type-3 codebook.

Two main cases exist for using one-shot HARQ-ACK request for Enhanced Type 3 HARQ-ACK codebooks. In case 1, the one-shot HARQ-ACK request can be indicated in a DCI format scheduling PDSCH reception (for example, the DCI includes a valid frequency domain resource assignment (FDRA) field). In case 2, the one-shot HARQ-ACK request can be indicated in a DCI format that does not schedule a PDSCH (for example, the FDRA field is invalid).

When a one-shot HARQ-ACK request is given on the DCI, for example, the ‘one-shot HARQ-ACK request’ field is set to ‘1,’ the UE 104 may refer to Table 1 for PDSCH scheduling and enhanced type 3 HARQ-ACK codebook lookup.

TABLE 1

| | “Enhanced Type 3 | “Enhanced Type 3 |
|---|---|---|
| | codebook indicator” is not | codebook indicator” is |
| | configured in the | configured in the |
| | triggering DCI | triggering DCI |
| FDRA field | PDSCH is not scheduled; | PDSCH is not scheduled; |
| is invalid | modulation and coding | “Enhanced Type 3 codebook |
| | scheme (MCS) field is | indicator” field is used to |
| | repurposed to indicate the | indicate the selected CB |
| | selected CB | |
| FDRA field | PDSCH is scheduled; | PDSCH is scheduled; |
| is valid | The first indexed e-Type 3 | “Enhanced Type 3 codebook |
| | CB is selected | indicator” field is used to |
| | | indicate the selected CB |

When a one-shot HARQ-ACK request is given on the DCI, the PDSCH-to-HARQ_feedback timing indicator field must not provide an inapplicable value from dl-DataToUL-ACK. In other words, a numerical K1 needs to be indicated along with a one-shot HARQ-ACK request.

If the DCI indicates a non-numerical K1, then a one-shot HARQ request can come in a later DCI. Thus, a first DCI scheduling a PDSCH (with a non-numerical K1) may be followed by a second DCI not scheduling a PDSCH given the timing for the HARQ-ACK in a numerical K1. Embodiments herein define how the DRX timers (for all the HARQ processes associated with the one-shot HARQ-ACK) are to be treated in such scenarios.

TS 38.213 accounts for the possibility of various other combinations of case ½ and numerical/non-numerical Kls. For example, other possibilities include only a first DCI not scheduling a PDSCH or only a second DCI scheduling a PDSCH.

Various updates to TS 38.321 may be provided in accordance with some embodiments to account for situations in which a Type-3 HARQ-ACK codebook request is provided with a DCI format that may or may not schedule a PDSCH reception.

In a first option, a separate DRX HARQ RTT timer DL and DRX retransmission timer DL may be introduced for the sole purpose of Type-3 HARQ-ACK codebook/one-shot HARQ-ACK requests. These timers may not be linked to any other HARQ processes. Utilization of these timers may be captured in the TS language dedicated to one-shot HARQ-ACK/Enhanced Type-3 HARQ-ACK codebook, which may be common to cases both with and without scheduling a PDSCH reception. For example, the language of TS 38.321, clause 5.7 may be updated with the underlined text as follows:

RRC controls DRX operation by configuring the following parameters:

...

| | |
|---|---|
| - | drx-RetransmissionTimerDL (one for Type-3 HARQ-ACK codebook and one |
| | per DL HARQ process except for the broadcast process): the maximum |
| | duration until a DL retransmission is received; |

...

| | |
|---|---|
| - | drx-HARQ-RTT-TimerDL (one for Type-3 HARQ-ACK codebook and one per |
| | DL HARQ process except for the broadcast process): the minimum duration |
| | before a DL assignment for HARQ retransmission is expected by the MAC |
| | entity; |

...

When DRX is configured, the MAC entity shall:
...

| | |
|---|---|
| 1> | if a drx-HARQ-RTT-TimerDL expires: |
| | 2> if the drx-HARQ-RTT-TimerDL is for Type-3 HARQ-ACK codebook: |

3> start the drx-RetransmissionTimerDL for Type-3 HARQ-ACK

codebook in the first symbol after the expiry of
drx-HARQ-RTT-TimerDL.

| | |
|---|---|
| 2> | else if the data of the corresponding HARQ process was not successfully |
| | decoded: |

| | |
|---|---|
| 3> | start the drx-RetransmissionTimerDL for the corresponding HARQ |
| | process in the first symbol after the expiry of drx-HARQ-RTT- |
| | TimerDL. |

...

```
1> if a DRX group is in Active Time:
...
  2> if the PDCCH indicates a One-shot HARQ-ACK request or
    includes a request for Enhanced Type-3 HARQ-ACK codebook
    report:
    3> start or restart the drx-HARQ-RTT-TimerDL for Type-3
      HARQ-ACK codebook in the first symbol after the end of the
      corresponding transmission carrying the DL HARQ
      feedback;
    3> stop the drx-RetransmissionTimerDL for Type-3
      HARQ-ACK codebook.
```

NOTE Z: When PUCCH cell switching is configured as specified in TS 38.213, the corresponding transmission carrying the DL HARQ feedback can happen on a different PUCCH cell.

A second option for capturing the DRX timing behavior dedicated to one-shot HARQ-ACK/Enhanced Type-3 HARQ-ACK codebook may be to selectively manage (for example, stop, start, restart) the timers for only a subset of the HARQ processes, for example, the ones that matter the most. This may be accomplished by updating TS 38.321, clause 5.7 to include the following text:

```
2> if the PDCCH indicates a One-shot HARQ-ACK request or
  includes a request for Enhanced Type-3 HARQ-ACK codebook
  report:
  3> for each HARQ process reported in the HARQ-ACK codebook
    for which neither the drx-HARQ-RTT-TimerDL nor the
    drx-RetransmissionTimerDL is running:
    4> start the drx-HARQ-RTT-TimerDL for the corresponding
      HARQ process in the first symbol after the end of the
      corresponding transmission carrying the DL HARQ
      feedback.
```

NOTE Z: When PUCCH cell switching is configured as specified in TS 38.213, the corresponding transmission carrying the DL HARQ feedback can happen on a different PUCCH cell.

It may be noted that the text of the first and second options does not specify a condition related to whether the DCI schedules or does not schedule a PDSCH reception. Thus, the text of both the first and second options may implicitly include both. For example, the first and second options may apply to cases both with and without scheduling a PDSCH reception.

Given the various options with which the one-shot HARQ-ACK request can be indicated or combined, it may be advantageous in some instances to treat the one-shot HARQ-ACK in the separate paragraph in TS 38.321 as described above. This may avoid referencing the case with/without scheduling a PDSCH and may also avoid duplicating definitions of what constitutes a corresponding HARQ process (out of the HARQ processes associated with the one-shot HARQ-ACK).

Embodiments describe various ways options to manage the HARQ RTT timers based on configuration and triggering aspects of Type-3 HARQ-ACK codebook.

These options provide manners in which a UE can select which HARQ processes will have their HARQ RTT timers started/restarted based on triggering conditions such as those discussed elsewhere herein.

A first option may include a first sub-option and a second sub-option. In the first sub-option, if the configuration of an enhanced Type-3 HARQ-ACK codebook is per HARQ (for example, through pdsch-HARQ-ACK-enhType3perHARQ), the UE 104 may start/restart the HARQ RTT timers for all the HARQ processes of the codebook. This may be feasible given that the list of HARQ processes to be reported based on the one-shot HARQ-ACK request in this situation is a subset of the total number of HARQ processes.

In the second sub-option, if the configuration of a Type-3 HARQ-ACK is per CC (for example, through pdsch-HARQ-ACK-enhType3per C (′) or a one-shot HARQ-ACK request is applied according to Release 16, the UE 104 may start the HARQ RTT timers for a subset of the HARQ processes of the codebook. The HARQ processes of the subset may be identified through a secondary/selective approach that includes identifying the HARQ processes reported in the HARQ-ACK codebook for which neither the drx-HARQ-RTT-TimerDI, nor the drx-Retransmission TimerDL is running.

A second option may be similar to the first option, but the entire list of HARQ processes configured in the pdsch-HARQ-ACK-enhType3perHARQ list may be used only if the triggering is via DCI with the pdsch-HARQ-enhType3D (′Ifield configured. If the triggering is done via DCI with the pdsch-HARQ-enhType3D (′Ifield configured, the DCI may be used to identify one list from a plurality of pdsch-HARQ-ACK-enh Type 3perHARQ lists that are configured, and the HARQ RTT timers for all HARQ processes from identified list may be started/restarted. If the pdsch-HARQ-enhType3D (′Ifield is not configured, an Enhanced Type-3 HARQ-ACK codebook can still be triggered through the one-shot HARQ-ACK request field on the DCI with pdsch-HARQ-ACK-enhType3List included. In this case, the secondary/selective approach described above with respect to the first option may be used to identify the subset of HARQ processes for which corresponding HARQ RTT timers are to be started.

In a third option, if one of the Release 17 options for enhanced Type-3 HARQ-ACK codebook is active, the UE 104 may apply DRX timer settings to the whole list of configured (and potentially reduced) number of HARQ processes. The secondary/selective approach may be used in all other cases.

In a fourth option, the DRX timers may be started/restarted for all HARQ processes associated with the HARQ-ACK codebook. This may apply to any Type-3 HARQ-ACK codebook.

In a fifth option, the secondary/selective approach may be used for all cases. For example, DRX timers may be started for each HARQ process reported in a HARQ-ACK codebook for which neither the drx-HARQ-RTT-TimerDL nor the drx-Retransmission TimerDL is running.

In a sixth option, one additional DRX HARQ RTT timer and one additional DRX retransmission timer may be provided for (enhanced) Type-3 HARQ-ACK codebook only, regardless of the HARQ processes involved.

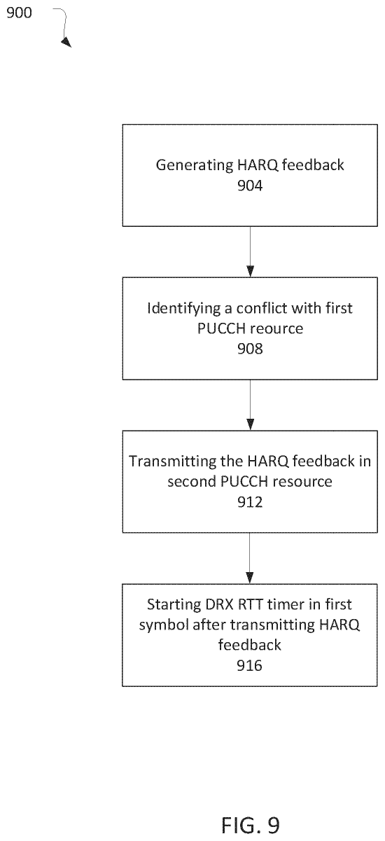

FIG. 9 illustrates an operation flow/algorithmic structure 900 in accordance with some embodiments. The operation flow/algorithmic structure 900 may be performed by a UE such as, for example, UE 104 or UE 1400, or components thereof, for example, processing circuitry 1404.

The operation flow/algorithmic structure 900 may include, at 904, generating HARQ feedback. The HARQ feedback may be generated based on an attempt to receive a downlink transmission, for example, a PDSCH transmission that carries a MAC PDU. The downlink transmission may be received in a configured downlink assignment (for example, an SPS assignment) or in any other manner.

The operation flow/algorithmic structure 900 may further include, at 908, identifying a conflict with first PUCCH resource. The first PUCCH resource may be the resource initially scheduled to carry the HARQ feedback. The conflict may be due to the PUCCH resource at least partially overlapping with downlink symbols, which may have a higher priority.

The operation flow/algorithmic structure 900 may further include, at 912, transmitting the HARQ feedback in a second PUCCH resource. The second PUCCH resource may occur later than the first PUCCH resource. For example, the second PUCCH resource may be in a slot that occurs after a slot having the first PUCCH resource.

The operation flow/algorithmic structure 900 may further include, at 916, starting a DRX RTT timer after transmitting the HARQ feedback. The DRX RTT timer may be started in the first symbol after transmitting the HARQ feedback. Some embodiments may further include stopping a DRX retransmission timer based on receiving the downlink transmission.

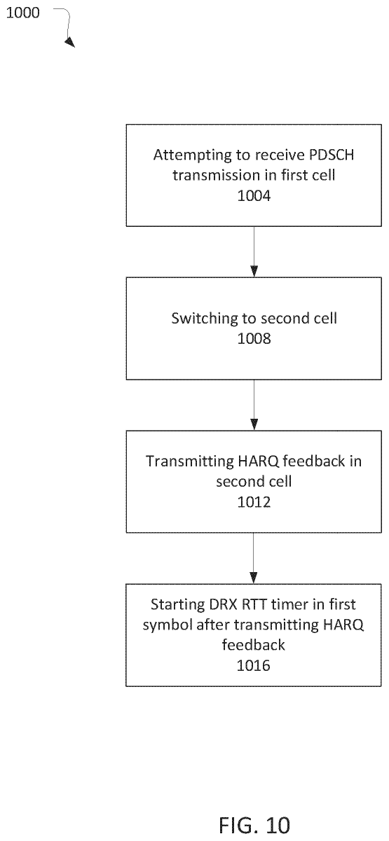

FIG. 10 illustrates an operation flow/algorithmic structure 1000 in accordance with some embodiments. The operation flow/algorithmic structure 1000 may be performed by a UE such as, for example, UE 104 or UE 1400, or components thereof, for example, processing circuitry 1404.

The operation flow/algorithmic structure 1000 may include, at 1004, attempting to receive PDSCH transmission in a first serving cell. The PDSCH transmission may carry a MAC PDU. The first serving cell, which may be a PCell or an SCell, may be provided on a first component carrier in a first band.

The operation flow/algorithmic structure 1000 may further include, at 1008, switching to a second serving cell. The second serving cell, which may be a PCell or an SCell, may be provided on a second component carrier in a second band.

In some embodiments, the switching between the first and second serving cells may be done according to a semi-static PUCCH carrier switching configuration or a dynamic PUCCH carrier switching configuration. RRC signaling may be used to provide the UE with the periodic cell switching pattern in order to enable the semi-static PUCCH carrier switching. Dynamic PUCCH carrier switching may be accomplished by the base station including an indication in DCI that prompts the UE to switch serving cells.

The operation flow/algorithmic structure 1000 may further include, at 1012, transmitting HARQ feedback in the second cell. The HARQ feedback may correspond to the attempt to receive the PDSCH transmission in the first serving cell. The HARQ feedback may be transmitted on a PUCCH resource of the second serving cell.

The operation flow/algorithmic structure 1000 may further include, at 1016, starting a DRX RTT timer after transmitting the HARQ feedback. The DRX RTT timer may be started in the first symbol after transmitting the HARQ feedback.

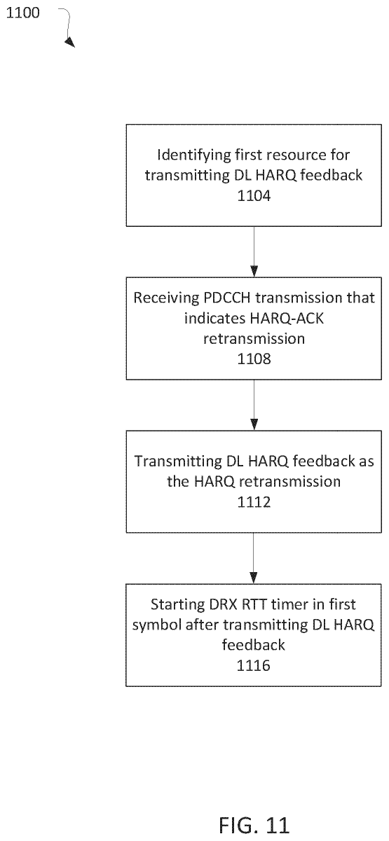

FIG. 11 illustrates an operation flow/algorithmic structure 1100 in accordance with some embodiments. The operation flow/algorithmic structure 1100 may be performed by a UE such as, for example, UE 104 or UE 1400, or components thereof, for example, processing circuitry 1404.

The operation flow/algorithmic structure 1100 may include, at 1104, identifying a first resource for transmitting DL HARQ feedback. The first resource may be a slot or a sub-slot. The DL HARQ feedback may correspond to an attempt to receive a downlink transmission. The first resource may be determined based on a timing of the attempt to receive the downlink transmission or may be scheduled by DCI.

The operation flow/algorithmic structure 1100 may further include, at 1108, receiving a PDCCH transmission that indicates a HARQ-ACK retransmission. The PDCCH transmission may be received in a resource that occurs after the first resource identified for transmitting the DL HARQ feedback.

The operation flow/algorithmic structure 1100 may further include, at 1112, transmitting DL HARQ feedback as the HARQ retransmission. The HARQ retransmission may be performed on a resource that occurs after the resource in which the PDCCH transmission was received.

In some embodiments, the UE may identify an offset and identify the DL HARQ feedback as the HARQ transmission based on the offset and the resource in which the PDCCH transmission is received.

The operation flow/algorithmic structure 1100 may further include, at 1116, starting a DRX RTT timer after transmitting the DL HARQ feedback. The DRX RTT timer may be started in the first symbol after transmitting the DL HARQ feedback. Some embodiments may further include stopping a DRX retransmission timer based on receiving the PDSCH transmission.

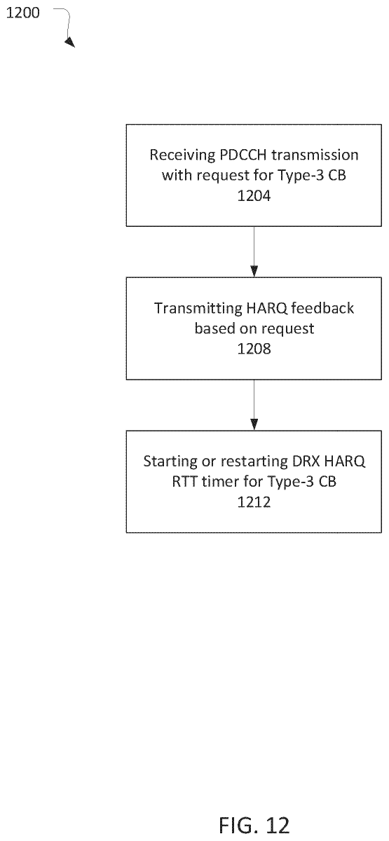

FIG. 12 illustrates an operation flow/algorithmic structure 1200 in accordance with some embodiments. The operation flow/algorithmic structure 1200 may be performed by a UE such as, for example, UE 104 or UE 1400, or components thereof, for example, processing circuitry 1404.

The operation flow/algorithmic structure 1200 may include, at 1204, receiving a PDCCH transmission with a request for a Type-3 codebook. The codebook may be a non-enhanced Type-3 codebook (for example, a Release 16 codebook) or an enhanced Type-3 codebook (for example, a Release 17 codebook). The request, which may be a DCI transmission, may be a one-shot HARQ-ACK request or a request for an enhanced Type-3 HARQ-ACK codebook report.

The operation flow/algorithmic structure 1200 may further include, at 1208, transmitting HARQ feedback based on the request. The HARQ feedback may include feedback for the HARQ processes of the corresponding Type-3 codebook. These may include some or all of the HARQ processes of the component carriers.

The operation flow/algorithmic structure 1200 may further include, at 1212, starting or restarting a DRX HARQ RTT timer for Type-3 codebook. The timer may be started or restarted in a first symbol that follows the symbol in which the HARQ feedback was transmitted. In some embodiments, a DRX retransmission timer for Type-3 HARQ-ACK codebook may be stopped based on receiving the PDCCH transmission.

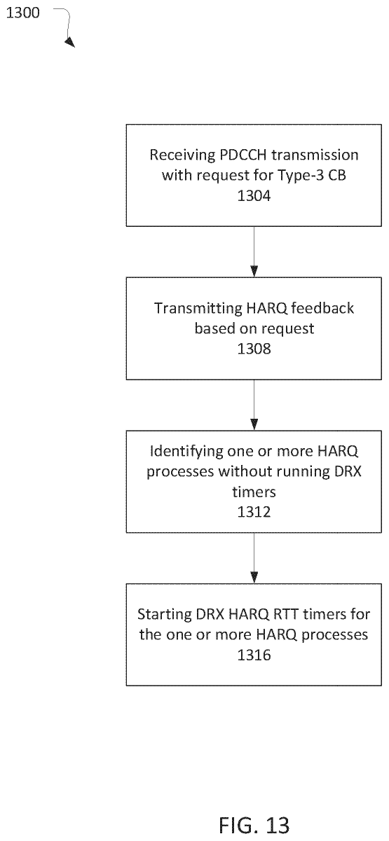

FIG. 13 illustrates an operation flow/algorithmic structure 1300 in accordance with some embodiments. The operation flow/algorithmic structure 1300 may be performed by a UE such as, for example, UE 104 or UE 1400, or components thereof, for example, processing circuitry 1404.

The operation flow/algorithmic structure 1300 may include, at 1304, receiving a PDCCH transmission with request for Type-3 codebook. The codebook may be a non-enhanced Type-3 codebook (for example, a Release 16 codebook) or an enhanced Type-3 codebook (for example, a Release 17 codebook). The request, which may be a DCI transmission, may be a one-shot HARQ-ACK request or a request for an enhanced Type-3 HARQ-ACK codebook report.

The operation flow/algorithmic structure 1300 may further include, at 1308, transmitting HARQ feedback based on the request. The HARQ feedback may include feedback for the HARQ processes of the corresponding Type-3 codebook. These may include some or all of the HARQ processes of the component carriers.

The operation flow/algorithmic structure 1300 may further include, at 1312, identifying one or more HARQ processes without running DRX timers. The DRX timers may be a DRX HARQ RTT timer or a DRX retransmission timer. In some embodiments, the identifying performed at 1312 may include identifying one or more HARQ processes that have neither a corresponding DRX HARQ RTT timer nor a corresponding DRX retransmission timer running.

The operation flow/algorithmic structure 1300 may further include, at 1316, starting DRX HARQ RTT timers for the one or more HARQ processes. Thus, the the DRX

HARQ RTT timers may be started for the HARQ processes that have neither DRX HARQ RTT timer nor DRX retransmission timer running upon transmission of a HARQ feedback.

FIGS. 9-13 describe operation flows/algorithmic structures from the perspective of a UE. However, as noted above, a base station may need to manage DRX HARQ timers in a manner similar to the UE in order to coordinate communications. Thus, embodiments may also include operation flows/algorithmic structures from the perspective of a base station similar to those described with respect to FIGS. 9-13 or any other embodiment herein.

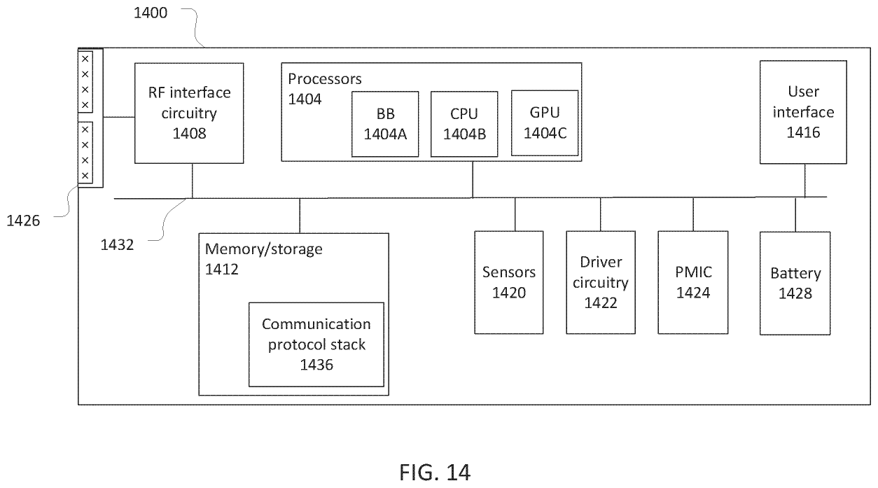

FIG. 14 illustrates a UE 1400 in accordance with some embodiments. The UE 1400 may be similar to and substantially interchangeable with UE 104 of FIG. 1.

The UE 1400 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack 1436 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400 including DRX as discussed herein.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

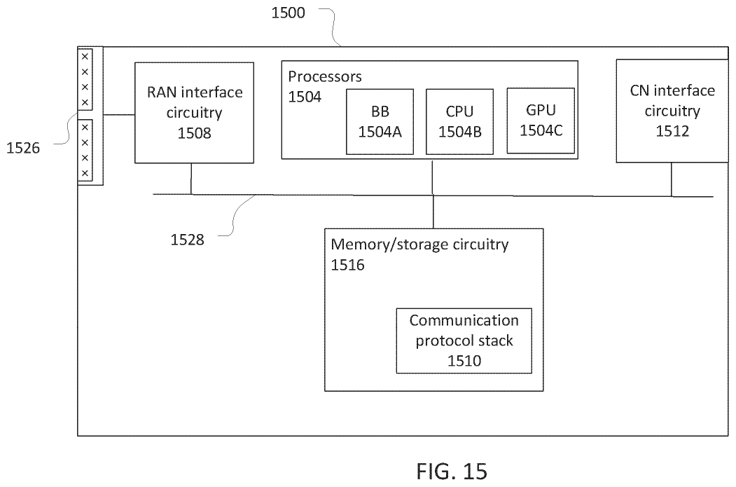

FIG. 15 illustrates a network node 1500 in accordance with some embodiments. The network node 1500 may be similar to and substantially interchangeable with base station 108 of FIG. 1.

The network node 1500 may include processors 1504, RF interface circuitry 1508 (if implemented as an access node), core network (CN) interface circuitry 1512, memory/storage circuitry 1516, and antenna structure 1526.

The components of the network node 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 12.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the base station 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

In some embodiments, the network node 1500 may be coupled with transmit receive points (TRPs) using the antenna structure 1526, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.
Example 1 includes a method comprising: generating hybrid automatic repeat request (HARQ) feedback based on an attempt to receive a media access control (MAC) protocol data unit (PDU) in a configured downlink assignment; identifying a conflict associated with a first physical uplink control channel (PUCCH) resource scheduled to carry the HARQ feedback; transmitting the HARQ feedback in a second PUCCH resource based on said identifying of the conflict; and starting a discontinuous reception (DRX) HARQ round-trip time (RTT) timer in a first symbol after transmitting the HARQ feedback.
Example 2 includes the method of example 1 or some other example herein, wherein further comprising: stopping a DRX retransmission timer based on receiving the MAC PDU.
Example 3 includes method of example 1 or some other example herein, wherein the configured downlink assignment comprises a semi-persistent scheduling (SPS) physical downlink shared channel (PDSCH).
Example 4 includes the method of example 1 or some other example herein, wherein the first PUCCH resource is in a first slot and the second PUCCH resource is in a second slot that occurs after the first slot.
Example 5 includes a method comprising: attempting to receive a physical downlink shared channel (PDSCH) transmission in a first serving cell; switching to a second serving cell after attempting to receive the PDSCH transmission; transmitting, in a physical uplink control channel (PUCCH) resource of the second serving cell, hybrid automatic repeat request (HARQ) feedback corresponding to attempt to receive the PDSCH transmission; and starting a discontinuous reception (DRX) HARQ round-trip time (RTT) timer in a first symbol after transmitting the HARQ feedback.
Example 6 includes a method of example 5 or some other example herein, further comprising: receiving a radio resource control (RRC) message that configures the UE with a periodic cell switching pattern; and switching to the second serving cell based on the periodic cell switching pattern.
Example 7 includes the method of example 6 or some other example herein, further comprising: attempting to receive the PDSCH transmission in a semi-persistent scheduling (SPS) downlink assignment.
Example 8 includes method of example 5 or some other example herein, further comprising: receiving an indication in downlink control information (DCI); and switching to the second serving cell based on the indication.
Example 9 includes the method of example 8 or some other example herein, further comprising: monitoring a physical downlink control channel (PDCCH); and detecting, based on said monitoring, a PDCCH transmission that schedules the PDSCH transmission.
Example 10 includes a method comprising: identifying a first resource for transmitting downlink (DL) hybrid automatic repeat request (HARQ) feedback; receiving a physical downlink channel (PDCCH) transmission that indicates a HARQ-acknowledgement (ACK) retransmission; transmitting the DL HARQ feedback as the HARQ-ACK retransmission in a physical uplink control channel (PUCCH) of a second resource; and starting a discontinuous reception (DRX) HARQ round-trip time (RTT) timer in a first symbol after transmitting the DL HARQ feedback.
Example 11 includes the method of example 10 or some other example herein, wherein the first resource is a first slot or sub-slot and the second resource is a second slot or sub-slot.
Example 12 includes the method of example 10 or some other example herein, wherein the PDCCH transmission does not schedule a downlink transmission.
Example 13 includes the method of example 10 or some other example herein, further comprising: stopping a DRX retransmission timer based on receiving the PDCCH transmission.
Example 14 includes a method of example 10 or some other example herein, wherein the PDCCH transmission is received in a third resource and the method further comprises: identifying an offset; and identifying the DL HARQ feedback based on the offset and the third resource.
Example 15 includes a method comprising: receiving a physical downlink control channel (PDCCH) transmission that includes a request to report a hybrid automatic repeat request (HARQ)-acknowledgment (ACK) codebook, wherein the request is a one-shot HARQ-ACK request or a request for an enhanced Type-3 HARQ-ACK codebook report; transmitting, based on the request, HARQ feedback corresponding to the HARQ-ACK codebook; and starting or restarting a discontinuous reception (DRX) hybrid automatic repeat request (HARQ) round-trip time (RTT) timer for Type-3 HARQ-ACK codebook after transmitting the HARQ feedback.
Example 16 includes the method of example 15 or some other example herein, wherein transmitting the HARQ feedback comprises transmitting the HARQ feedback in a first symbol and the method further comprises: starting or restarting the DRX HARQ RTT timer for Type-3 HARQ-ACK codebook in a second symbol that follows the first symbol.
Example 17 includes the method of example 15 or some other example herein, further comprising: stopping a DRX retransmission timer for Type-3 HARQ-ACK codebook based on receiving the PDCCH transmission.
Example 18 includes a method comprising: receiving a physical downlink control channel (PDCCH) transmission that indicates a one-shot hybrid automatic repeat request (HARQ)-acknowledgment (ACK) request or includes a request for an Enhanced Type-3 HARQ-ACK codebook report; transmitting, based on the PDCCH transmission, HARQ feedback corresponding to a plurality of HARQ processes of a HARQ-ACK codebook; identifying one or more HARQ processes of the plurality of HARQ process that have neither a corresponding discontinuous reception (DRX) hybrid automatic repeat request (HARQ) round-trip time (RTT) timer nor a corresponding DRX retransmission timer running; and starting a DRX HARQ RTT timer corresponding to each of the one or more HARQ processes.
Example 19 includes the method of example 18 or some other example herein, wherein transmitting the HARQ feedback comprises transmitting the HARQ feedback in a first symbol and the method further comprises: starting a DRX HARQ RTT timer corresponding to each of the one or more HARQ processes in a second symbol that follows the first symbol.
Example 20 includes the method of example 19 or some other example herein, further comprising: determining a DRX HARQ RTT timer for a first HARQ process of the plurality of HARQ processes is running; abstaining from restarting the DRX HARQ RTT timer for the first HARQ process based on said transmitting of the HARQ feedback.
Example 21 includes a method comprising: receiving a request to report a Type-3 hybrid automatic repeat request (HARQ)-acknowledgement (ACK) codebook with HARQ feedback information for a set of HARQ processes of one or more component carriers; reporting the Type-3 HARQ-ACK codebook; selecting one or more HARQ processes from the set of HARQ processes; and starting or restarting discontinuous reception (DRX) HARQ timers corresponding to the one or more HARQ processes.
Example 22 includes the method of example 21 or some other example herein, wherein the Type-3 HARQ-ACK codebook is an enhanced Type-3 HARQ-ACK codebook and the method further comprises: receiving, from a base station, information to configure the enhanced Type-3 HARQ-ACK codebook.
Example 23 includes method of example 22 or some other example herein, wherein the information is to configure the enhanced Type-3 HARQ-ACK codebook using a per HARQ process and component carrier (CC) configuration, and the one or more HARQ processes includes all HARQ processes of the set of HARQ processes.
Example 24 includes the method of example 22 or some other example herein, wherein the information is to configure the enhanced Type-3 HARQ-ACK codebook using a per HARQ process and component carrier (CC) configuration and the method further comprises: if the request is received via downlink control information (DCI), selecting the one or more HARQ processes to include all HARQ processes of the set of HARQ processes; and if the request is not received via DCI, selecting the one or more HARQ processes to include HARQ processes of the set of HARQ processes that have neither a discontinuous reception (DRX) hybrid automatic repeat request (HARQ) round-trip time (RTT) timer or a DRX retransmission timer running.
Example 25 includes a method of example 22 or some other example herein, wherein the information is to configure the enhanced Type-3 HARQ-ACK codebook using a per HARQ process and component carrier (CC) configuration and the method further comprises: if the request is received with a downlink control information (DCI) field configured to dynamically indicate a list of HARQ processes from a plurality of lists of HARQ processes, selecting the one or more HARQ processes to include all HARQ processes of the list of HARQ processes; and if the request is received without a DCI field configured to dynamically indicate a list of HARQ processes from a plurality of lists of HARQ processes, selecting the one or more HARQ processes to include HARQ processes of the set of HARQ processes that have neither a discontinuous reception (DRX) hybrid automatic repeat request (HARQ) round-trip time (RTT) timer nor a DRX retransmission timer running.
Example 26 includes a method of example 22 or some other example herein, wherein the information is to configure the enhanced Type-3 HARQ-ACK codebook using a per component carrier (CC) process, and said selecting the one or more HARQ processes includes selecting a subset of HARQ processes from the set of HARQ processes.
Example 27 includes the method of example 26 or some other example herein, wherein selecting the subset of HARQ processes comprises: selecting HARQ processes of the set of HARQ processes that have neither a discontinuous reception (DRX) hybrid automatic repeat request (HARQ) round-trip time (RTT) timer or a DRX retransmission timer running.
Example 28 includes a method of example 21 or 22 or some other example herein, further comprising: selecting the one or more HARQ processes to include all HARQ processes of the set of HARQ processes.
Example 29 includes the method of example 21 or 22 or some other example herein, further comprising: selecting the one or more HARQ processes to include HARQ processes of the set of HARQ processes that have neither a discontinuous reception (DRX) hybrid automatic repeat request (HARQ) round-trip time (RTT) timer or a DRX retransmission timer running.
Example 30 includes a method of example 21 or some other example herein, wherein the DRX HARQ timers comprise a DRX round-trip time (RTT) timer and a DRX retransmission timer dedicated to Type-3 HARQ-ACK codebooks.
Example 31 includes a method comprising: transmitting a physical downlink channel (PDCCH) transmission that indicates a hybrid automatic repeat request (HARQ)-acknowledgement (ACK) retransmission; receiving downlink HARQ feedback as the HARQ-ACK retransmission in a physical uplink control channel (PUCCH) transmission; and starting a discontinuous reception (DRX) HARQ round-trip time (RTT) timer in a first symbol after receiving the DL HARQ feedback.
Example 32 includes the method of example 31 or some other example herein, wherein the PDCCH transmission does not schedule a downlink transmission.
Example 33 includes the method of example 31 or some other example herein, further comprising: stopping a DRX retransmission timer based on transmitting the PDCCH transmission.
Example 34 includes the method of example 31 or some other example herein, receiving the PDCCH transmission in a third resource and the method further comprises: identifying an offset; and identifying the DL HARQ feedback based on the offset and the third resource.
Example 35 may include an apparatus comprising means to perform one or more elements of a method described in or related to any of examples 1-34, or any other method or process described herein.
Example 36 may include one or more non-transitory computer-readable media comprising instructions to cause an electronic device, upon execution of the instructions by one or more processors of the electronic device, to perform one or more elements of a method described in or related to any of examples 1-34, or any other method or process described herein.
Example 37 may include an apparatus comprising logic, modules, or circuitry to perform one or more elements of a method described in or related to any of examples 1-34, or any other method or process described herein.
Example 38 may include a method, technique, or process as described in or related to any of examples 1-34, or portions or parts thereof.
Example 39 may include an apparatus comprising: one or more processors and one or more computer-readable media comprising instructions that, when executed by the one or more processors, cause the one or more processors to perform the method, techniques, or process as described in or related to any of examples 1-34, or portions thereof.
Example 40 may include a signal as described in or related to any of examples 1-34, or portions or parts thereof.
Example 41 may include a datagram, information element, packet, frame, segment, PDU, or message as described in or related to any of examples 1-34, or portions or parts thereof, or otherwise described in the present disclosure.
Example 42 may include a signal encoded with data as described in or related to any of examples 1-34, or portions or parts thereof, or otherwise described in the present disclosure.
Example 43 may include a signal encoded with a datagram, IE, packet, frame, segment, PDU, or message as described in or related to any of examples 1-34, or portions or parts thereof, or otherwise described in the present disclosure.
Example 44 may include an electromagnetic signal carrying computer-readable instructions, wherein execution of the computer-readable instructions by one or more processors is to cause the one or more processors to perform the method, techniques, or process as described in or related to any of examples 1-34, or portions thereof.
Example 45 may include a computer program comprising instructions, wherein execution of the program by a processing element is to cause the processing element to carry out the method, techniques, or process as described in or related to any of examples 1-34, or portions thereof.
Example 46 may include a signal in a wireless network as shown and described herein.
Example 47 may include a method of communicating in a wireless network as shown and described herein.
Example 48 may include a system for providing wireless communication as shown and described herein.
Example 49 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-24. (canceled)

25. One or more non-transitory, computer-readable media having instructions that, when executed, cause processor circuitry to:
identify a first resource for transmitting downlink (DL) hybrid automatic repeat request (HARQ) feedback;
receive a physical downlink control channel (PDCCH) transmission that indicates a HARQ-acknowledgement (ACK) retransmission;
transmit the DL HARQ feedback as the HARQ-ACK retransmission in a physical uplink control channel (PUCCH) of a second resource; and
start a discontinuous reception (DRX) HARQ round-trip time (RTT) timer in a first symbol after transmitting the DL HARQ feedback.

26. The one or more non-transitory, computer-readable media of claim 25, wherein the first resource is a first slot or sub-slot and the second resource is a second slot or sub-slot.

27. The one or more non-transitory, computer-readable media of claim 25, wherein the PDCCH transmission does not schedule a downlink transmission.

28. The one or more non-transitory, computer-readable media of claim 25, wherein the instructions, when executed, further cause the processor circuitry to:
stop a DRX retransmission timer based on receiving the PDCCH transmission.

29. The one or more non-transitory, computer-readable media of claim 25, wherein the PDCCH transmission is received in a third resource and the instructions, when executed, further cause the processor circuitry to:
identify an offset; and
identify the DL HARQ feedback based on the offset and the third resource.

30. The one or more computer-readable media of claim 25, wherein both the DL HARQ feedback and the DRX HARQ RTT timer are associated with a HARQ process.

31. An apparatus
comprising processor circuitry to:
receive a physical downlink control channel (PDCCH) transmission that indicates a feedback, wherein the feedback is one-shot hybrid automatic repeat request (HARQ) feedback or a retransmission of HARQ feedback;
generate, based on the PDCCH transmission, the feedback for transmission; and
start or restart a discontinuous reception (DRX) HARQ round-trip time (RTT) timer based on transmission of the feedback; and
interface circuitry to communicatively couple the processor circuitry to a component of a device.

32. The apparatus of claim 31, wherein the feedback is to be transmitted in a first symbol and the processor circuitry is further to:
start or restart the DRX HARQ RTT timer in a second symbol that follows the first symbol.

33. The apparatus of claim 31, wherein the processor circuitry is further to:
stop a DRX retransmission timer for Type-3 HARQ-ACK codebook based on receiving the PDCCH transmission.

34. The apparatus of claim 31, wherein the DRX HARQ RTT timer is for a Type-3 HARQ-ACK codebook.

35. The apparatus of claim 31, wherein both the feedback and the DRX HARQ RTT timer are associated with a HARQ process.

36. The apparatus of claim 31, wherein the feedback is a one-shot hybrid automatic repeat request (HARQ) feedback.

37. The apparatus of claim 31, wherein the feedback is a retransmission of HARQ feedback.

38. A method comprising:
receiving a physical downlink control channel (PDCCH) transmission that indicates a feedback, wherein the feedback is one-shot hybrid automatic repeat request (HARQ) feedback or a retransmission of HARQ feedback;
generating, based on the PDCCH transmission, the feedback for transmission; and
starting or restarting a discontinuous reception (DRX) hybrid automatic repeat request (HARQ) round-trip time (RTT) timer based on transmission of the feedback.

39. The method of claim 38, wherein the feedback is to be transmitted in a first symbol and the method further comprises:
starting or restarting the DRX HARQ RTT timer in a second symbol that follows the first symbol.

40. The method of claim 38, wherein the method further comprises:
stopping a DRX retransmission timer for Type-3 HARQ-ACK codebook based on receiving the PDCCH transmission.

41. The method of claim 38, wherein the DRX HARQ RTT timer is for a Type-3 HARQ-ACK codebook.

42. The method of claim 38, wherein both the feedback and the DRX HARQ RTT timer are associated with a HARQ process.

43. The method of claim 38, wherein the feedback is a one-shot hybrid automatic repeat request (HARQ) feedback.

44. The method of claim 38, wherein the feedback is a retransmission of HARQ feedback.
